(19) United States
(12) Patent Application Publication
(10) Pub. No.: US 2010/0131339 A1
(43) Pub. Date: May 27, 2010

(54) System and Method to Transform Website User Information into Sales Prospects, Sales Leads and Sales Intelligence

(76) Inventor: Rakesh Singh, Antioch, CA (US)

Correspondence Address: Rakesh Singh, 2704 Balboa Ct, Antioch, CA, 94509, US

(21) Appl. No.: 12/623,006

(22) Filed: Nov. 20, 2009

Related U.S. Application Data
(60) Provisional application No. 61/117,097, filed on Nov. 22, 2008.

(51) Int. Cl. G06Q 30/00; G06Q 10/00; G06F 15/16; G06F 17/30

(52) U.S. Cl. 705/10; 709/224; 707/709; 707/E17.108

(57) ABSTRACT

A method collects data about each website user from multiple sources, transforms this data into information suitable for sales leads, analyzes the raw data and the transformed information for multiple related website users, and packages all such relevant information across multiple related website users into sales lead information capsules that can then be distributed individually to third parties.

### CROSS REFERENCE TO RELATED APPLICATIONS

This application claims priority under 35 USC 119(e) of U.S. Provisional Application Ser. No. 61/117,097, filed on Nov. 22, 2008 and entitled “Method to Transform Website Visitor Information into Sales Prospect, Sales Leads and Sales Intelligence”, which is hereby incorporated by reference in its entirety.

### FIELD OF THE INVENTION

This invention relates to business intelligence, more specifically to sales lead generation, prospect intelligence, customer intelligence and competition intelligence.

### BACKGROUND OF THE INVENTION

In business, finding prospects that will lead to new customers has been and continues to be the most critical and the most challenging stage in the sales process. Generally, the sales pipeline comprises of the following stages.

Build a List of Suspects. This is first stage of the sales pipeline. At this stage a suspect is only a name. In fact, it may only be the company name. Seller may not know the contact name of the buyer most likely to purchase their products and services. Or, if they have a name, it may be a reader of a publication, a listener to a radio station, or an attendee at a trade show, and seller doesn't know if this person is an interested buyer. Seller only suspects this “entity” is a target for their products or services.

Engage Suspect/Prospect. This stage usually happens during the Suspect to Prospect conversion phase. Engaging a suspect can involve their inquiry with the seller or seller contacting them, but does require the seller to have interacted with the suspect (either through marketing or sales efforts) to introduce the seller and its offering, and uncover their general need.

Qualify Lead. Having engaged the suspect and having determined that they fit the seller's overall target profile, the seller needs to qualify the lead further to make sure it is a “fit” with the seller and its offering.

Assess Opportunity. Once the lead is qualified using pre-defined criteria, the seller assesses the opportunity before spending the resources to develop a quote or proposal. The seller does research to understand the key factors driving the prospects' buying criteria such as, what are the specifics of their need, what is the main decision-making factor, what is their budget, do they understand seller's value proposition, and are they looking at competitors?

Propose. At this stage the seller creates a detailed proposal to meet the decision maker's needs. At this stage it is advisable to include all the terms in the proposal to avoid slowing down the approval, and therefore the sales process.

Close The Deal. At this stage, the seller follows up to uncover and resolve any possible objections, negotiate terms, and close the deal.

SALE! This is final the stage of the sales pipeline.

The market currently has several lead generation solutions to broaden the sales pipeline and many marketing and sales automation systems to automate the different stages of the sales pipeline. However, since many of the leads are unqualified to begin with, a lot of time and money is wasted on sales and marketing efforts to unqualified leads. The existing solutions do not have a way to identify the suspect/prospect who is specifically looking for the seller's products and solutions.

Traditional lead generation is based on list building, email blast, cold calling, telemarketing, PR and advertising. Traditional prospect intelligence solutions are based on web text mining technology which mines web pages but not user activities and therefore they are unable to capture prospects when they are looking for the seller's products and solutions. Traditional ad networks and lead-exchange systems are ad based which require users to take some action (fill a form or click on ad). Prospects and suspects are becoming ad blind and ads dilute the brand of the content website. This results in lost opportunity to capture a majority of suspects/prospects.

Ad and form-fill based monetization produces negligible revenue for the content website which has low traffic but high quality users. Ads take up valuable visual space on the website, which could have been used to engage the user.

This invention solves all of the above problems.

### SUMMARY OF THE INVENTION

In the present invention, lead generation involves the interaction of three parties:

User—this is a person visiting a website. A user is a prospect when he/she is interested in buying a product or service. A user having a specific need searches the internet & visits websites. User's browsing patterns, mouse clicks and mouse movements can reveal his/her interest and his/her level of engagement. IP lookup and contact database lookup can reveal his/her location, company details and contact details. The information collected about a prospect is considered the “Lead” that a seller wants to collect.

Website—this is the host of the web page content. A web site produces content that a user is interested in viewing. Leads can be generated from a website, when the website uses the present invention by embedding tracking code in the web pages.

Seller—a seller is a person or entity that has a product it wants to sell, an item it wants to publicize, a newsletter for which it wants the user to sign up or offers a service it wants to sell. A seller may also simply be interested in obtaining user information for marketing or product development reasons. A seller may be a third party or may be the website host itself. There are numerous other scenarios for sellers but the ones listed are some of the typical scenarios. A seller buys the leads generated from the websites.

In general, the present invention is a method and system for collecting and storing information about each user; collecting and storing information about each user's domain context; creating and storing a user profile for each user and then transforming this information to a plurality of sales leads that are stored and delivered (in real-time or scheduled) to sellers.

In some embodiments, sales leads are analyzed to further transform and package a plurality of sales leads into a plurality of related sales lead information capsules that can be independently distributed to sellers.

In some embodiments, the present invention creates a hierarchy of keywords from users' browsing patterns and then maps this keyword hierarchy to domain specific industry taxonomy.

In some embodiments, the invention offers features to distribute sales leads to sellers. There is a web interface for sellers to create accounts, then search and buy sales leads. Seller interface has account management and lead management and reporting features. There are features for leads delivery (to email, to phone, to CRM applications, to social media accounts etc.) There is also an admin interface to manage accounts for group of sellers.

In some embodiments, the invention offers advanced features for the sellers to access his/her account through an API. APIs can be used to programmatically login, search and buy leads. APIs can also be used for lead management, account management and downloading reports. These features allow integration of the present invention with third party applications.

In some embodiments, there is a web interface to create accounts for websites. This interface has account management and reporting features. There is a feature to set the price for the leads generated by a specific website. There is also a feature to manage multiple websites from one account.

### BRIEF DESCRIPTION OF THE DRAWINGS

FIG. 1 shows a flow chart modeling the overall method and system of the invention;

FIG. 2 describes the real-time web page to server communication that transmits user's browsing data to remote server;

FIG. 3 describes IP lookup process to get user's contact and company details;

FIG. 4 describes the process to generate user's domain context; and

FIG. 5 illustrates a typical networked computer system that is suitable for practicing the preferred embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

In one embodiment, the invention can use a tracking script, which can be client-based Javascript code in some embodiments. The Javascript monitors the user's browsing activity in the background and sends data to the server. The Javascript does not interfere with the user's browsing experience.

In some embodiments, when the web page loads inside the user's browser, the user's browser requests the tracking script from a server. The server can then transmit the tracking script to the user's browser.

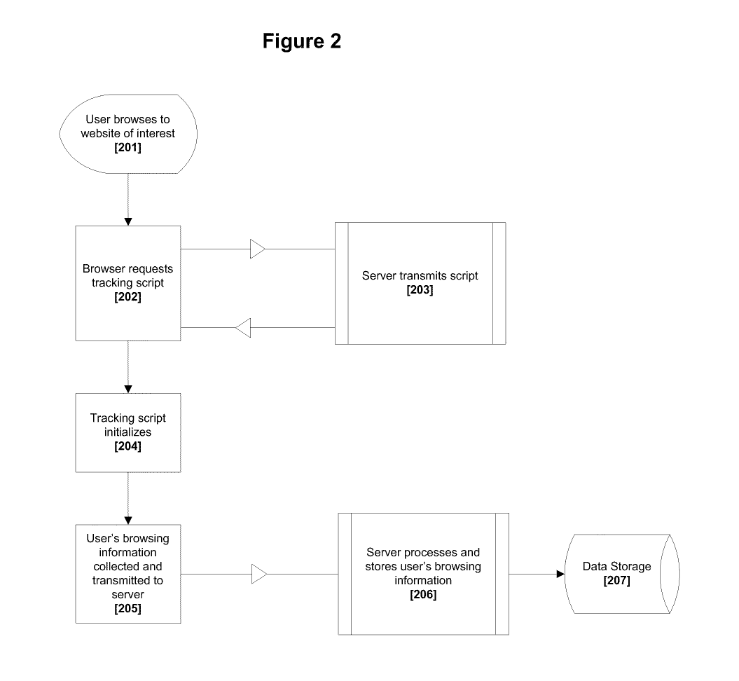

FIG. 2 illustrates the process of loading the tracking script from the remote server and sending the user's browsing information to the remote server.

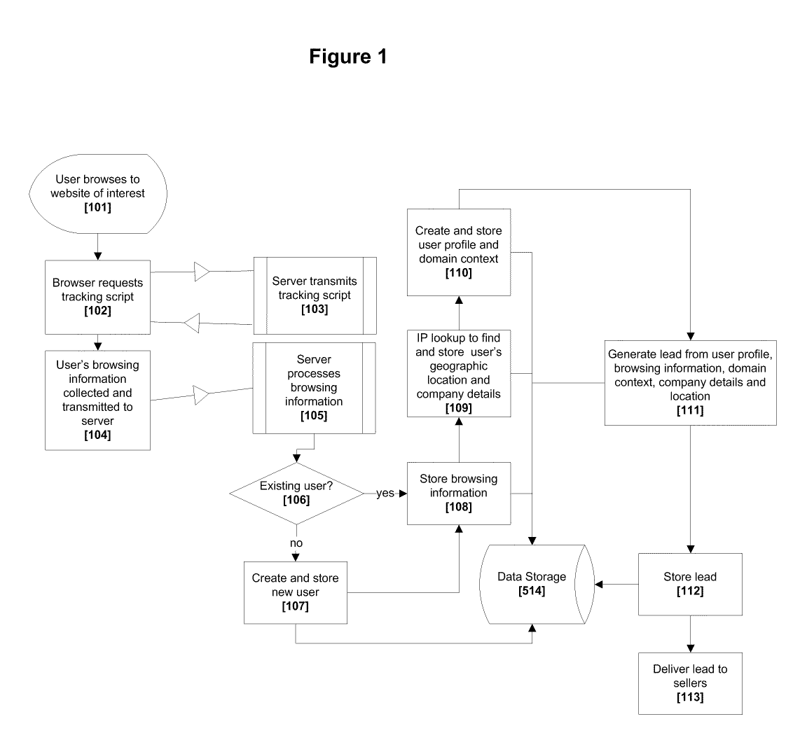

In some embodiments, the hosting web site, i.e., the web site being visited by the user, does not need to host the Javascript code. The hosting web site needs only to insert a brief section of HTML code. That section of HTML code will reference a JavaScript file that will initiate the system. The invention will then manage the entire life-cycle of the lead generation: data collection, getting the user's company and contact details, getting the user's domain context, creating leads and delivering leads to sellers. See FIG. 1 for overall method.

In some embodiments, the method uses IP lookup to find user's company name, company website domain address, and geographical location of the user.

In some embodiments, the method uses company name and company website domain to get company details (website url, revenue, industry type, number of employees, details of company employees [title, department, location, email, phone etc.], decision makers, and organization chart etc.).

In some embodiments, the method the uses the user's company name, domain, browsing information and location to get the user's contact details, title and department.

If the user cannot be identified then the method suggests possible contacts from the user's company. Possible contacts are suggested based on the user's browsing information, location, and domain context. Seller can provide a list of keywords to filter from suggested contacts. Seller can also provide his/her own list of suggested contacts to be used in this scenario.

The invention can use a crawler to get the above details (0036, 0037, and 0038) from third party data sources, internal data sources and seller provided data sources. Standard data mining and machine learning techniques can be used to aggregate, transform, and categorize data (both structured and non-structured) from different sources.

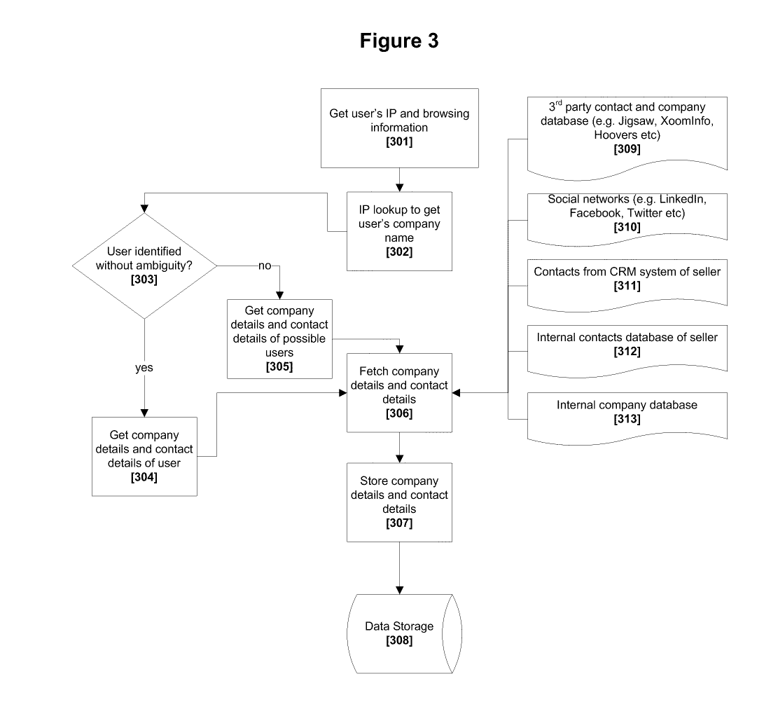

FIG. 3 describes the method of getting company and contact details of the user.

In some embodiments, the method uses the user's company details, location, and browsing information to crawl different data sources (internal or external) for related information about user's browsing interest. Crawled data is aggregated, transformed, categorized, and stored as domain context of the user. Standard data mining and machine learning techniques can be used to transform and categorize the data (which can be both structured and non-structured).

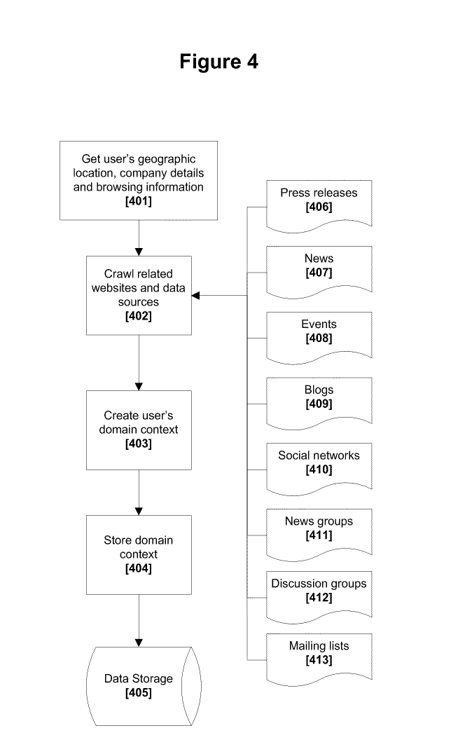

FIG. 4 describes the method of creating domain context of the user.

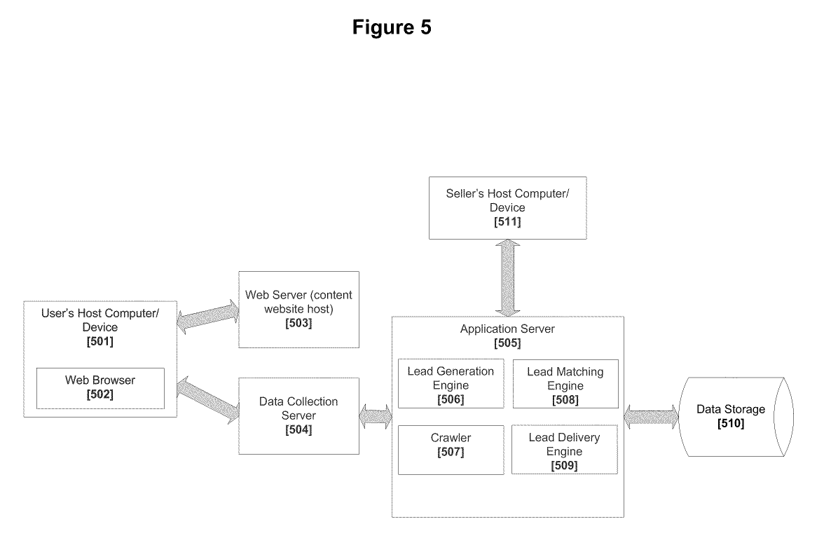

FIG. 5 illustrates one embodiment of a networked computer system capable of practicing embodiments of the invention. User's host computer 501 may be any computing device, preferably including a processor (controller, CPU), a memory and a display, and being capable of connecting to an electronic computer network, such as a LAN or the Internet, and preferably able to run a web browser application 502. In the course of browsing web pages on the Internet, user's host computer 501 may connect via the network to web server 503, which serves content web pages to user's host computer 501 and is configured to work with the present invention. The content web page sent to a user that is running host computer 501 contains references, e.g., by HTML code, to data collection server 504, which transmits tracking script to web browsers, such as that running on host computer 501, and receives browsing information sent there from.

Data sent from host computer 501 is passed from data collection server 504 to back-end application server 505. Application server 505 handles the bulk of the data processing in the system of the invention, and contains lead generation engine 506, crawler 507, lead matching engine 508, and lead delivery engine 509. Lead matching engine 508 matches a lead to a seller. Lead matching is done with a variety of data factors.

As is understood by one skilled in the computer arts, multiple host computers 501, multiple web servers 503, multiple data collection servers 504, multiple application servers 505, multiple data stores 510, and multiple seller host computers 511 may be used in the present invention, as is the case with all network based technology. Furthermore, the functionality of web server 503, data collection server 504, application server 505, and data store 510 may be combined into fewer units for efficiency or business reasons. The embodiment of FIG. 5 is a base case of the preferred embodiment, depicting all major components in the singular. However, elements of FIG. 5 may be duplicated or removed without departing from the scope of the present invention.

Similarly, each server or unit described herein may advantageously include a memory and a processor (e.g., controller, CPU) that may execute instructions stored in the memory to perform the functions with respect to embodiments of the method, as described herein. Embodiments of such devices within the invention may also include a computer readable medium, such as for example a memory, a disk drive or a USB flash memory, including instructions that, when executed by a processor or controller, carry out methods disclosed herein.

As persons of ordinary skill are aware, servers contain both hardware and software. The particular power and other requirements and thus the preferable hardware for a given application are determined by the amount of data that needs to be processed, and the ability to store, process and transmit the data.

When a plurality of servers are used in combination they may communicate with one another via a network switch, while two or more web servers work in tandem utilizing a network Load-Balancer to direct incoming traffic equally between them. For example, one may use four web servers, two application servers, and two database servers operably coupled to one another. The software of the present invention is a combination of computer executable code that runs on the aforementioned servers and is stored on a computer program device that is part of the hardware. There also may be computer executable code running in the form of client-side JavaScript code that is embedded in the web sites web page and executes in each users web browser. This client-side code communicates with the server-side code sending data to data collection system.

The present invention has been described with certain degree of particularity. Those versed in the art will readily appreciate that various modifications and alterations may be carried out without departing from the scope of the following claims.

What is claimed is:

1. A computer implemented method of collecting information about each website user from a plurality of sources, then transforming the information collected into a plurality of sales leads each of which would comprise of:
name and contact information of the user (if identified without ambiguity) or names and contact information of possible users (if there is ambiguity); and
name of the company; and
location of the user; and
user intent e.g., job seeker or sales lead looking for a specific product or a product family or a solution or a solution family etc.; and
text and non-text elements which were of interest to the user (combination of hypertext, anchor text in hyperlinks, page title, meta-tags, search terms used, text and non-text elements on the referring page, text and non-text elements either clicked on or hovered on by the user etc.); and
pages visited during the visit and all visible text and non-text elements on all the pages visited along with text and non-text elements extracted from mouse movement and mouse hovering information on all the pages visited; and
campaign information—if the user's website visit was a result of a marketing or sales campaign such as an email or a webinar or a search engine campaign or a tradeshow etc., the information related to the campaign; and
all the above information from past visits by this user; and
all the above information from past visits by all users from this company; and
all the above information from past visits by related companies; and
all the above information from past users who may share any of the above elements in common with this user; and
cluster of above information based on company name, keywords, and phrases.

2. The method of claim 1, wherein collected information about each website user comprises of:
user's browsing information; and
user's geographic location; and
user's contact details; and
user's company details; and
user's domain context.

3. The method of claim 2, wherein user's browsing information comprises of:
date and time of visit; and
user's click pattern and mouse movement data; and
URL (URL structure, URL path, query strings) of the referring page; and
title, meta-tags, text, hyperlinks, anchor text, hypertext, and non-text elements on the referring page; and
hypertext or hyperlinks or anchor text clicked on; and
hypertext or hyperlinks or anchor text hovered on; and
text (other than hypertext) clicked or hovered on; and
time spent hovering over a hyperlink/hypertext/anchor text, over other text, and over non-text elements; and
text (other than hypertext) not clicked or not hovered on; and
non text elements hovered on, clicked on, not hovered on, and not clicked on; and
title and meta-tags of pages visited by the user; and
similar (including the above information) information from previous visits to this website from the same user; and
similar (including the above information) information from previous visits to this website from users of the same company; and
similar (including the above information) information from previous visits to other websites from the same user; ands similar (including the above information) information from previous visits to other websites from users of the same company; and
number of pages visited, time spent, number of repeat visits, number of unique users from the same company; and
information from other sources that may have affected the user's visit to the website that may be an event or news information that may have been read by the user.

4. The method of claim 2, wherein contact details comprise of: name, email addresses, phone numbers, and other contact details of the user if the user can be identified without ambiguity.

5. The method of claim 2, wherein contact details comprise of names, email addresses, phone numbers, and other contact details of possible users if there is ambiguity about the identity of the user—such information will be obtained from other databases that list people in various companies along with their names, email addresses, location information, and phone numbers.

6. The method of claim 5, wherein using information from this visit, past visits, website specific information (such as general profile of users to this website) to narrow down a list of possible users.

7. The method of claim 2, wherein domain context comprises of the following information from a plurality of third party sources:
URL of the page; and
keywords and phrases on the web page; and
anchor texts on the web page; and
update date for the web page.

8. The method of claim 7, wherein third party sources comprise of:
websites covering press releases, news and events related to keywords (and phrases) on the pages visited by user; and
websites covering press releases, news and events related to anchor text clicked by user; and
websites covering press releases, news and events related to anchor text on which user did mouse hover; and
websites covering press releases, news and events related to user's company; and
websites covering press releases, news and events related to user's location; and
any website containing above keywords or phrases, user company name, user location.

9. A computer implemented method to analyze multiple related sales leads to further transform and package a plurality of sales leads into a plurality of related sales lead information capsules that can be independently distributed to third parties.

10. Seller user interfaces to search, buy and tag leads.

11. The method of claim 10, wherein seller can search leads based on date and time of user's visit.

12. The method of claim 10, wherein seller can search leads based on keywords, user's location, user's company location, and website.

13. The method of claim 10, wherein seller can save search criteria.

14. The method of claim 13, wherein seller can configure his/her account to deliver a lead to his/her email, phone, CRM applications and social networking accounts etc. in real-time as soon as a lead is generated matching seller's search criteria.

15. The method of claim 14, wherein seller can configure his/her account to deliver the leads periodically (daily, weekly etc.).
